(19) United States
(12) Patent Application Publication
(10) Pub. No.: US 2026/0278726 A1
(43) Pub. Date: Sep. 17, 2026

(54) Intelligent Rideshare Matching System

(71) Applicant: Laquan Austion, Arlington, VA (US)

(72) Inventor: Laquan Austion, Arlington, VA (US)

(21) Appl. No.: 19/565,832

(22) Filed: Mar. 13, 2026

Related U.S. Application Data
(60) Provisional application No. 63/771,156, filed on Mar. 13, 2025.

(51) Int. Cl. G06Q 50/47; G06Q 10/42

(52) U.S. Cl. CPC G06Q 50/47; G06Q 10/42

(57) ABSTRACT

A system for facilitating fulfilling experiences during rideshare travel opportunities, the system matching individuals in shared rideshare trips based on availability, destination, mutual interests, user preferences, etc., employing AI-driven matching algorithms and machine learning protocols to enhance the matching functionality in real-time, and employing integration with third-party social media and travel services platforms, communication features to facilitate ongoing connection between rideshare companions, and feedback functionality to train and improve the system through machine learning algorithms and AI functionality.

### FIELD OF THE INVENTION

This invention relates to a system and method for intelligently matching individuals for networking or dating during rideshare commutes. Utilizing machine learning, user preferences, and verified profiles, the system ensures meaningful connections while prioritizing safety and convenience.

### BACKGROUND OF THE INVENTION

The information age has seen various aspects of everyday life transition to the digital world. Dating and professional networking as well as third-party transportation are just a few such aspects of everyday life that individuals have become more and more accustomed to engaging through modern technology platforms. Examples of such platforms from the dating industry include Tinder, Bumble, and the like. Many modern professionals manage professional relationships and networking through platforms such as LinkedIn, and users seeking a quick ride across town will often resort to services such as Uber or Lyft rather than hailing a taxi or arranging other professional transportation services.

Meanwhile, modern professionals and singles often struggle to expand their networks or meet like-minded individuals due to time constraints. Engagement with dating apps may require arduous review of numerous third-party profiles before a user finds someone he or she is interested in meeting. Likewise with respect to professional networking, where many modern professionals take time out of their busy schedules to attend networking events, engage with other members of their professions, and cultivate personal and professional relationships with other professionals who may or may not ultimately become a worthwhile connection.

Likewise, personal and professional travel, and particularly local travel, siphons off even more time that modern professionals simply do not have. From lining up a ride, to waiting curbside, to a ride across town for a meeting or other engagement, individuals spend precious hours weekly that they cannot use otherwise. Some transportation services provide for cost-savings in the form of ride-sharing, but there remains a significant need for a way to maximize the use of time spent on local traveling. Likewise, modern professionals need new and innovative ways to expand dating, personal connection, and professional networking opportunities in their ever-busy lives.

### SUMMARY OF THE INVENTION

Enter the Two Birds™ technology platform of the present invention, which solves these and other problems by providing a smart matching system that integrates with rideshare APIs and professional networking and dating platforms to enable users to be matched with verified individuals during shared rides. It is thus an object of the present invention to enable users to multitask during commute times and other local travel by sharing rides with other users for personal or professional networking, dating, or just interesting conversations. It is further an object of the present invention to facilitate those connections during rideshares by identifying user matches based on shared interests, shared destinations, and other user-driven criteria. It is also an object of the present invention to facilitate such matchmaking by building a network of individuals interested in using their commutes for more than just travel.

To achieve these and other objectives, the present invention provides, in preferable embodiments, a system for matching individuals in shared rideshare trips based on mutual interests. The system preferably provides a user interface allowing individuals to select networking or dating preferences. Preferable embodiments of the system of the present invention employ an AI-driven matching algorithm that pairs users based on common interests, ride availability, and user profiles, with machine-learning features to improve the matching results over time the more frequently a user engages with the system.

The system also preferably employs integration techniques with third-party rideshare APIs, such as Uber and Lyft, to facilitate automatic ride booking and matching. The system also preferably includes a communication system that enables matched users to engage before, during, and after the ride and a post-ride evaluation system for rating, follow-up connections, future ride planning, and enhancement of the machine-learning and AI protocols to refine pairings over time.

Preferable embodiments of the present invention also employ features to enhance safety and security of users during their travels, including, user profile verification and background checks, in-use system reporting features, and optional ride recording. These features enhance what is already a predominantly safe environment for users due to the presence of the third-party rideshare provider. Such enhanced safety features may, in preferable embodiments, also integrate with certain dating applications to ensure user identity authentication.

Preferable embodiments of the system of the present invention further provide communication interfaces allowing users to chat and view user profiles, and even third-party application dating profiles, of potential rideshare matches, and provide topics of conversation based on mutual interests to help brake the ice early on in what can otherwise become strained or awkward introductions. And the system of the present invention preferably provides post-ride features enabling users to rate their matches, exchange contact information with other rideshare participants, schedule future ride pairings, and assist the system's machine learning and AI algorithms to improve the user's experience.

The present invention leverages AI, verified networking/dating platforms, and rideshare services to revolutionize the way people connect during their daily commutes and other local travel. The system transforms wasted travel time into valuable opportunities for personal and professional interactions and growth.

As those skilled in the art will appreciate, the present invention is not limited to the embodiments and arrangements described above. Other objects of the present invention and its particular features and advantages will become more apparent from consideration of the following drawings and detailed description of the invention.

### BRIEF DESCRIPTION OF THE DRAWINGS

FIG. 1 depicts a flowchart illustrating certain preferable features of the system and user experience according to exemplary embodiments of the present invention.

FIG. 2 illustrates aspects of the user interface according to the exemplary embodiments of the present invention illustrated in FIG. 1.

FIG. 3 illustrates a visual depiction of certain preferable features of the system according to exemplary embodiments of the present invention.

### DETAILED DESCRIPTION OF THE INVENTION

The following detailed description illustrates the technology by way of example, not by way of limitation of the principles of the invention. This description will enable one skilled in the art to make and use the technology, and describes several embodiments, adaptations, variations, alternatives and uses of the invention, including what is presently believed to be the best mode of carrying out the invention. One skilled in the art will recognize alternative variations and arrangements, and the present technology is not limited to those embodiments described hereafter.

Preferable embodiments of the present invention revolutionize rideshare scheduling and engagement with AI-powered matchmaking algorithms, machine learning, and other innovative features that seamlessly integrate with known dating and networking platforms, such as LinkedIn, Tinder, Bumble, and Grindr, to connect riders that are already matched or have expressed interest in connecting through such platforms. By additionally leveraging the rideshare networks of known transportation service providers, such as Uber and Lyft, the present invention transforms daily commutes, everyday trips, and other local travel into real-time opportunities to meet up, eliminating the hassle of endless profile review, messaging, scheduling, and logistics required to utilize classic dating and networking services.

The present invention turns rideshare travel into meaningful connections, enabling users to find compatible co-riders while reaching their destinations and creating spontaneous social and professional interactions in a safe and controlled environment. The present invention merges mobility and travel with social media and connection, addressing two fundamental user needs in the digital age—connection and convenience—in one seamless system and platform.

Preferable embodiments of the present invention utilize AI-powered compatibility matching algorithms to match users based on ride patterns, career focus, preferences, social interests, and prior social connections. The system utilizes AI to find the most compatible rideshare companions for any given instance of travel, whether a commute to or from the office, a trip across town for a conference, or a quick lunch excursion. The system of the present invention utilizes AI to find a companion who is not only traveling in the same direction, around the same time, and from similar locations, but filters those potential companions based on user interests and preferences, a desire for romantic, personal, or professional connection, general compatibility given prior rideshare experiences driven by the system's matching protocols, feedback from users on perfecting said matching protocols for each individual experience, etc.

For example, a user of the system might be leaving the office and traveling to a networking event across town late in the day. The user of the present invention, who is already preparing for a night of professional networking, may desire to maximize her time spent traveling by starting her networking activities during the trip. Such a circumstance is the perfect opportunity to utilize the system of the present invention, which can identify another user also interested in a rideshare from around the same location at around the same time to around the same destination who is also interested in professional networking.

Maybe the users are even ultimately headed to the same networking event. The present invention facilitates a connection between those two users that precedes the networking event itself, giving each a professional connection for the networking event. And if not, the users have had an opportunity to create an even more intimate, one-on-one connection during their travel that is more likely to last beyond the networking event. And they have done so without spending any additional time or resources, in fact saving resources by splitting the costs associated with the travel. Accordingly, the present invention facilitates substantial benefits during a time that each user would have otherwise “wasted” merely traveling.

Some preferable embodiments of the present invention also feature prioritized matching for certain users, which facilitates more rapid rideshare matching and added companion selection options. So busy professionals on the go that utilize the service provided by the present invention regularly can get rapid rideshare matching and have the opportunity to prioritize more meaningful connections using preferable embodiments of the technology. Prioritized user profiles may appear higher in the rideshare queue, may be emphasized when presented to potential rideshare companions, and may receive faster matching and pickup times, in some preferable embodiments.

Other features of some preferable embodiments of the system include ability to choose music genre for the ride ahead of time, aspects associated with rideshare companion and/or driver, automobile choice, topics of conversation (e.g. avoid political discussions), etc. Some preferable embodiments include user profile scoring and trust system, which can be improved by positive rideshare companion feedback, avoiding last-minute cancelations, feedback from travel providers, etc. Other users may then view and select those rideshare companions with high ratings or other preferable attributes.

In some preferable embodiments, the AI and machine learning algorithms may anticipate user's rideshare preferences and prepare for expected rideshare requests. For example, for a user who commutes to and from the same locations generally every day and typically requests a rideshare companion for romantic purposes, preferable embodiments of the present invention may queue up potential rideshare matches for around the user's commute times and may even, in some preferable embodiments, communicate the availability of a desirable rideshare companion to said user, through mobile device push notifications or other features known to those of skill in the art.

Some preferable embodiments of the system of the present invention also facilitate payment of fees, travel costs, etc. by incorporating a digital wallet or other payment system, as will be understood to those of skill in the art, adding to the convenience and efficiency of the user experience with the present invention.

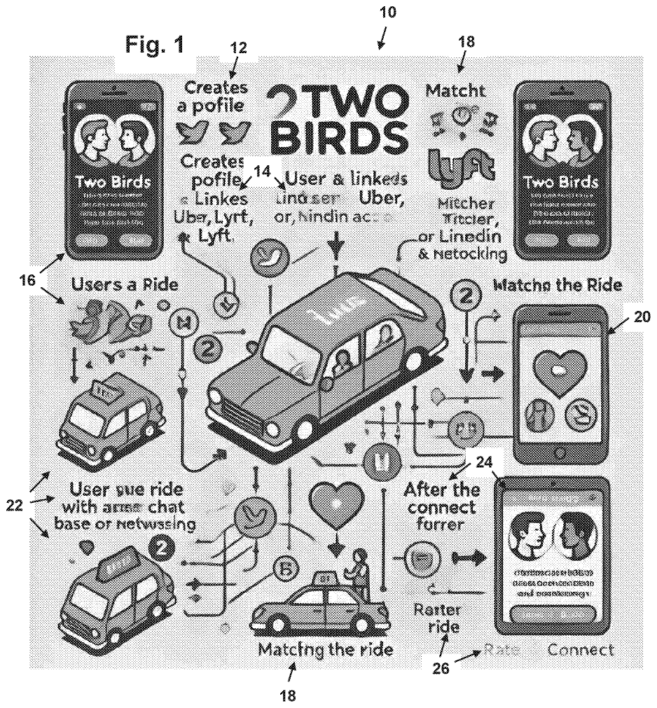

Referring now to FIG. 1, an exemplary schematic of the user experience with and certain preferable features of preferable embodiments of the present invention is depicted. As shown, users create a profile 12 with the system 10 of the present invention. In preferable embodiments, the user may share certain interests, preferences, and other personal information during the profile creation process, which preferable embodiments of the system 10 can then use to facilitate rideshare matching, preference building, etc. Some preferable embodiments of the system 10 can integrate 14 with other known social media profiles, such as Facebook, Tinder, Bumble, Grindr, LinkedIn, etc. and, with the user's permission, import user information and assess preferences therefrom, utilizing AI guided algorithms and features in preferable embodiments.

When a user of the system 10 wants to schedule a ride with a rideshare companion, he or she can access the system 10, via a mobile app, website, etc., as will be understood to those of skill in the art, and indicate desired time and destination. Preferable embodiments will permit the user to share his or her location through geolocation technology, particularly when using a mobile device, as will be known to those of skill in the art, or may be prompted to enter a pickup location if location services are inaccessible for any reason.

Upon receiving the rideshare request 16, preferable embodiments of the system 10 of the present invention will employ AI-driven matching protocols to identify one or more potential rideshare companions 18. Preferable embodiments of the present invention may permit the user seeking rideshare services to select from a list of potential matches, filter the potential matches based on criteria such as gender, location of residence, connection interest (e.g. romantic, personal or professional connection, etc.), and other common interests like music, culture, etc. Preferable embodiments of the present invention employ AI to emphasize potential matches based on an assessment of the requesting user and employ machine learning to improve the performance of the match selection criteria based on prior user selections and user feedback.

Preferable embodiments of the present invention preferably integrate 14, using APIs or otherwise, as will be understood by those of skill in the art, with other travel services, such as Uber and Lyft, to facilitate the rideshare matching protocols. Such features may, in some preferable embodiments, also facilitate matching with non-users of the system 10 of the present invention through integration 14 with the third-party travel services.

Users may, in preferable embodiments, select certain other criteria associated with the travel experience 20, such as type of music that will be played during the ride, potential topics of conversation and mutual interest, nature of rideshare companion and driver, whether demographic or otherwise, etc. Those of skill in the art will recognize various optional selection criteria that can be incorporated within preferable embodiments of the present invention.

During travel, rideshare companions will have the opportunity to interact, share common interests, engage in personal or professional network building, and the like 22. Upon arrival at their respective destinations, the system 10 of the present invention preferably includes features that allow for ongoing connection and communication, including without limitation a database of associated users/individuals, chat room and/or direct messaging features, and the like 24.

Preferable embodiments of the present invention further provide each user the opportunity to provide feedback 26 to the system 10, including feedback associated with the matching performance, the rideshare companion, the driver/vehicle, etc. Such feedback 26 may be used, in some preferable embodiments, to apply a public or private “performance score” to each user and/or ride provider. Preferable embodiments of the present invention further use such feedback 26 to improve, in real-time and over time, the performance of the system's 10 matching algorithms, machine learning protocols, and AI features and performance.

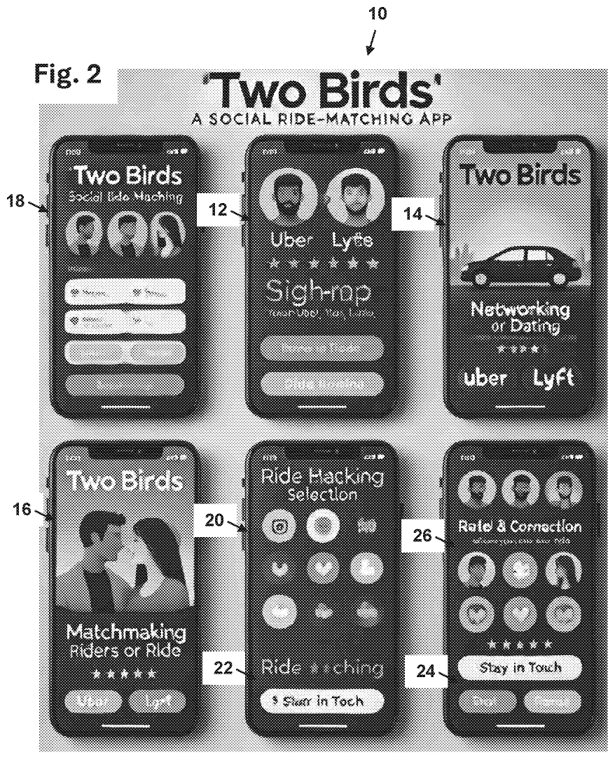

Referring now to FIG. 2, depicted are several exemplary renderings of aspects of the user interface associated with the system 10 of the present invention, as provided through a mobile application. As shown, the user may observe, interact, and make updates to his own user profile and preferences 12 upon accessing the service 10. Such profile and preference criteria 12 are used by the present invention's AI-driven matching protocols 18 to improve the matchmaking performance of the system 10.

The system 10 also provides, as depicted, users the opportunity to integrate 14 with other travel services and social media platforms to improve the system's 10 functionality and understanding of the user's preferences and travel habits 12. When seeking a rideshare experience 16, users may select, in preferable embodiments, the nature of their goals for the rideshare experience 16, such as a companion that might present a romantic interest, or a professional network opportunity, or just a platonic personal connection based upon mutual interests.

Users may be presented with potential rideshare companions 18, in some preferable embodiments, or may be permitted to allow the system 10 to select a rideshare companion for them, if that is their preference, in some preferable embodiments. Maximizing the personalization and freedom of each user's use of the system 10 is a primary objective of the present invention.

Upon selecting a rideshare companion 18, preferable embodiments of the present invention may facilitate pre-ride interaction through direct messaging features and the like 22. Upon arrival of the rideshare vehicle, the rideshare companions will have the opportunity to connect, network, and otherwise engage in the intimate personal experience of sharing the ride. Once the ride is over, preferable embodiments of the system 10 facilitate ongoing communication through individualized network tracking, direct communication features, and the like 24, as will be understood to those of skill in the art.

Each user of the rideshare system 10 then has the opportunity to provide feedback 26 to preferable embodiments of the present invention to improve the personalized experience for the next rideshare event 16, and preferable embodiments of the present invention utilize said feedback 26 in improving the service through machine learning and AI in real-time. So, for example, the system 10 of the present invention will operate to improve its functionality from the time a rideshare is completed on the way to lunch to the time a rideshare is scheduled to return from lunch. As those of skill in the art will recognize, the more individual experiences 16 a user engages in through the system 10, the better the system 10 will become at facilitating future rideshare experiences 16 for that user, and the more users engage with the system 10, the better the system 10 will become at facilitating rideshare experiences 16 for any and all users.

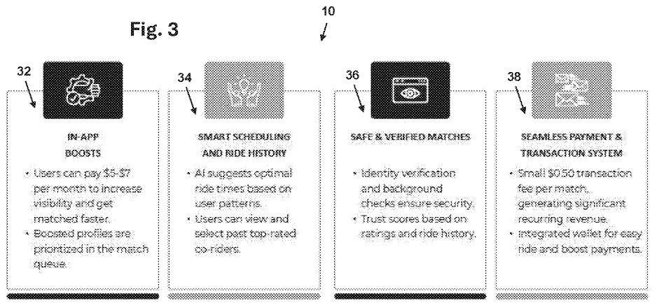

Referring now to FIG. 3, certain preferable features of preferable embodiments of the present invention are presented. Preferable embodiments of the present invention include, for example, the ability for users to obtain premium or enhanced services 32, including faster matching, faster access to available vehicles/drivers, profile emphasis in match selection features, etc. Preferable embodiments also employ AI and machine learning algorithms to assess user preferences and habits 12 to enhance the individualized experience 34 within the system 10.

Some preferable embodiments also employ certain security protocols and features 36, such as background checks for new users, authentication protocols for user-provided information, tracking and scoring of users'interactions within the system 10, and the like. Those of skill in the art will recognize the value and optionality of such security features 36, which may be included or excluded in some preferable embodiment based on user selection and preferences 12.

To facilitate convenience and efficiency of use within the system 10 of the present invention, some preferable embodiments incorporate payment services 38, such as the use of a digital wallet, to facilitate payment to ride providers, etc. through the system 10. Such features avoid interruption to the personal connection and rideshare experience at the moment of payment, as can be the case with classic travel services, such as taxis and the like. As noted, it is a primary objective of the present invention to make each user's individualized experience as convenient, efficient, and rewarding as possible, as these aspects become more and more coveted in the modern world.

While the present invention has been described with reference to particular embodiments and arrangements of parts, features, and the like, it is not limited to these embodiments or arrangements. Indeed, modifications and variations will be ascertainable to those of skill in the art, all of which are inferentially and inherently included in these teachings.

What is claimed is:

1. A system for electronically arranging transportation concurrently with one or more additional users, comprising:
one or more user devices, each connected to a network;
a system architecture connected to the network and comprising one or more databases, the one or more databases storing information about users of the system and individualized user data comprising one or more of identifying information, preferences, habits, and activities associated with each user;
the system architecture further comprising a user data module operating to receive and store, in the one or more databases, information about users of the system, the user data module employing one or more user data module protocols to identify and assess the individualized user data, the one or more user data module protocols of the user data module employing artificial intelligence and machine learning features;
the system architecture further comprising a rideshare request module operating to receive a requesting user's rideshare request and associated request data, said associated request data comprising the requesting user's present location, pickup location, and destination;
the system architecture further comprising a rideshare matching module operating to identify at least one companion user's rideshare request and associated request data, to facilitate the reservation of a travel provider for the requesting user and the at least one companion user, and to share the requesting user's rideshare request and associated request data and the at least one companion user's rideshare request and associated request data with the travel provider, the rideshare matching module employing one or more rideshare matching protocols to ensure a match between the requesting user's rideshare request and associated request data and the at least one companion user's rideshare request and associated request data, the one or more rideshare matching protocols of the rideshare matching module employing artificial intelligence and machine learning features.

2. The system of claim 1, wherein the system architecture is operable to receive data from third-party systems connected to the network.

3. The system of claim 1, wherein the user data module is further operable to receive the individualized user data via inputs from the users through a graphical user interface displayed on the users'one or more user devices connected via the network.

4. The system of claim 1, wherein the rideshare request module further comprises geolocation services for identifying the requesting user's present location.

5. The system of claim 1, wherein the associated request data received by the rideshare request module further comprises one or more additional rideshare request preferences selected from the group consisting of romantic, personal, or professional connection, gender of the at least one companion user, common tastes in music, culture, politics, and ideology, social interests, careers, locations of residence, and demographics.

6. The system of claim 1, wherein the rideshare matching module further comprises one or more protocols to identify the at least one companion user and associated individualized user data, said at least one companion user having submitted a rideshare request and associated request data that matches the requesting user's rideshare request and associated request data, forming a list of the at least one companion user and associated individualized user data, and presenting said list of the at least one companion user and associated individualized user data for selection.

7. The system of claim 1, wherein the system architecture further comprises a user interaction module operating to facilitate communication between at least two users for whom the users'rideshare requests and associated request data were identified as a match by the rideshare matching module.

8. The system of claim 7, wherein the user interaction module comprises one or more of a direct messaging interface and a user data exchange protocol operating to transfer user data directly from one user's one or more user devices to another user's one or more user devices.

9. They system of claim 1, wherein the system architecture further comprises a user feedback module operating to obtain feedback from the requesting user on the system architecture's performance, the user feedback module comprising one or more feedback protocols to receive and store the feedback in the one or more databases and to communicate the feedback to the user data module to update the user preferences and activities and to the rideshare matching module to improve the one or more rideshare matching protocols, the one or more feedback protocols of the user feedback module employing artificial intelligence and machine learning features.

10. The system of claim 9, wherein the one or more feedback protocols comprises one or more of an experience rating protocol for rating the overall rideshare experience, a match rating protocol for rating the performance of the rideshare matching module, a driver rating protocol for rating the travel provider, and a user notes interface for instructing the system architecture on how to improve the user's experience.

11. A system for electronically arranging transportation, comprising:
one or more user devices, each connected to a network;
a system architecture connected to the network, operable to receive data from third-party systems connected to the network. and comprising one or more databases, the one or more databases storing information about users of the system and individualized user data comprising one or more of identifying information, preferences, habits, and activities associated with each user;
the system architecture further comprising a user data module operating to receive and store, in the one or more databases, information about users of the system, the user data module employing one or more user data module protocols to identify and assess individualized user data, the one or more user data module protocols of the user data module employing artificial intelligence and machine learning features;
the system architecture further comprising a rideshare request module operating to receive a requesting user's rideshare request and associated request data, said associated request data comprising the requesting user's present location, pickup location, and destination;
the system architecture further comprising a rideshare matching module operating to identify at least one companion user's rideshare request and associated request data and employing one or more rideshare matching protocols to identify a match between the requesting user's rideshare request and associated request data and the at least one companion user's rideshare request and associated request data, the one or more rideshare matching protocols of the rideshare matching module employing artificial intelligence and machine learning features.

12. The system of claim 11, wherein the user data module is further operable to receive the individualized user data via inputs from the users through a graphical user interface displayed on the users'one or more user devices connected via the network.

13. The system of claim 11, wherein the rideshare request module further comprises geolocation services for identifying the requesting user's present location.

14. The system of claim 11, wherein the associated request data received by the rideshare request module further comprises one or more additional rideshare request preferences selected from the group consisting of romantic, personal, or professional connection, gender of the at least one companion user, common tastes in music, culture, politics, and ideology, social interests, careers, locations of residence, and demographics.

15. The system of claim 11, wherein the rideshare matching module further comprises one or more protocols to identify the at least one companion user and associated individualized user data, said at least one companion user having submitted a rideshare request and associated request data that matches the requesting user's rideshare request and associated request data, forming a list of the at least one companion user and associated individualized user data, and presenting said list of the at least one companion user and associated individualized user data for selection.

16. The system of claim 15, wherein the rideshare matching module further operates to facilitate the reservation of a travel provider for the requesting user and the at least one companion user, and to share the requesting user's rideshare request and associated request data and the at least one companion user's rideshare request and associated request data with the travel provider.

17. The system of claim 11, wherein the system architecture further comprises a user interaction module operating to facilitate communication between at least two users for whom the users'rideshare requests and associated request data were identified as a match by the rideshare matching module.

18. The system of claim 17, wherein the user interaction module comprises one or more of a direct messaging interface and a user data exchange protocol operating to transfer user data directly from one user's one or more user devices to another user's one or more user devices.

19. They system of claim 11, wherein the system architecture further comprises a user feedback module operating to obtain feedback from the requesting user on the system architecture's performance, the user feedback module comprising one or more feedback protocols to receive and store the feedback in the one or more databases and to communicate the feedback to the user data module to update the user preferences and activities and to the rideshare matching module to improve the one or more rideshare matching protocols, the one or more feedback protocols of the user feedback module employing artificial intelligence and machine learning features.

20. The system of claim 19, wherein the one or more feedback protocols comprises one or more of an experience rating protocol for rating the overall rideshare experience, a match rating protocol for rating the performance of the rideshare matching module, a driver rating protocol for rating the travel provider, and a user notes interface for instructing the system architecture on how to improve the user's experience.
